(19) United States
(12) Patent Application Publication
(10) Pub. No.: US 2003/0178047 A1
(43) Pub. Date: Sep. 25, 2003

(54) Substrate processing apparatus and substrate cleaning method

(75) Inventor: Sadao Hirae, Kyoto (JP)

Correspondence Address: OSTROLENK FABER GERB & SOFFEN, 1180 AVENUE OF THE AMERICAS, NEW YORK, NY, 100368403

(73) Assignee: Dainippon Screen Mfg. Co., Ltd.

(21) Appl. No.: 10/382,612

(22) Filed: Mar. 5, 2003

(30) Foreign Application Priority Data
Mar. 25, 2002 (JP) 2002-082698

(51) Int. Cl. B08B 3/00

(52) U.S. Cl. 134/26; 134/34; 134/95.2; 134/95.3; 134/103.3; 134/157; 134/198

(57) ABSTRACT

A substrate processing apparatus is provided with an IPA spouting nozzle in opposition to an objective surface of a substrate supported by a support part. A nozzle swinging mechanism swingably supports the IPA spouting nozzle through an arm. An IPA supply pipe and a nitrogen gas supply pipe are connected to the IPA spouting nozzle. IPA and nitrogen gas supplied from these supply pipes are mixed with each other in the IPA spouting nozzle for forming IPA droplets. The formed IPA droplets are spouted toward the objective surface of the substrate. Consequently, the objective surface of the substrate can be cleaned with IPA. Thus provided is the substrate processing apparatus cleaning the substrate hard to clean with deionized water.

### BACKGROUND OF THE INVENTION

1. Field of the Invention

The present invention relates to a substrate processing apparatus processing a substrate with IPA.

2. Description of the Background Art

In general, a substrate processing apparatus is employed for supplying various processing solutions to a semiconductor substrate or a glass substrate (hereinafter referred to as “substrate”) thereby processing the substrate. In substrate processing, cleaning also plays an important role, and physical cleaning of physically removing particles from the surface of the substrate with a brush or the like or chemical cleaning of cleaning the surface of the substrate with a chemical solution is performed.

A method of spouting droplets of deionized water toward the substrate has recently been proposed as a cleaning method exhibiting a cleaning effect superior to that of the chemical cleaning while preventing electronic circuit pattern rupture on the substrate problematic in the physical cleaning. According to this cleaning method, the droplets of deionized water spouted toward the substrate at a high speed may be electrified to influence electronic elements formed on the substrate. Therefore, deionized water prepared by dissolving carbon dioxide, for example, having low specific resistance is employed as a cleaning liquid in order to prevent electrification.

In the substrate processing apparatus, on the other hand, isopropyl alcohol (hereinafter abbreviated as “IPA”) is generally employed for drying the cleaned substrate. For example, IPA is discharged onto the substrate for replacing the processing solutions or the deionized water employed for processing the substrate with IPA thereby drying the substrate with no drying streaks. Alternatively, droplets of IPA formed in a nozzle mixing gas and liquid with each other are spouted into a processing space storing substrates stacked and arranged at prescribed intervals for replacing deionized water or the like adhering to the substrates with the IPA floating in the processing space.

In recent years, a water-repellent film or a porous film having holes with a small dielectric constant has been watched as an interlayer dielectric film of a semiconductor device. However, the surface of the water-repellent film having a small dielectric constant cannot be sufficiently cleaned with deionized water having large surface tension, while the porous film is hydrophobic, and hence it is unpreferable to clean these films with deionized water.

When the deionized water having low specific resistance prepared by dissolving carbon dioxide is employed in the cleaning method of spouting droplets toward the substrate, copper wires or the like provided on the substrate may be corroded, and influence of such corrosion is unignorable in a semiconductor device having increasingly refined wires.

### SUMMARY OF THE INVENTION

The present invention is directed to a substrate processing apparatus.

According to the present invention, the substrate processing apparatus comprises a support part supporting a substrate and a nozzle part spouting IPA droplets toward an objective surface of the substrate supported by the support part.

The substrate processing apparatus can clean the substrate with the IPA droplets, so that the substrate can be properly cleaned even if the same is hard to clean with deionized water.

Preferably, the forward end of the nozzle part is made of conductive resin, and the IPA droplets can be inhibited from electrification.

More preferably, the substrate processing apparatus further comprises an air current formation part forming an air current directed toward the back surface of the substrate from the objective surface around the support part. The concentration of IPA gas can be reduced around the support part.

The present invention is also directed to a substrate cleaning method.

Accordingly, an object of the present invention is to clean a substrate with a cleaning liquid other than that of deionized water only.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 schematically illustrates the structure of a substrate processing apparatus according to a first preferred embodiment of the present invention;

FIG. 2 is a longitudinal sectional view of a nozzle part;

FIG. 3 illustrates the inner part of a cover of the substrate processing apparatus;

FIG. 4 illustrates the flow of operations for processing a substrate;

FIG. 5 illustrates an operation of swinging the nozzle part;

FIG. 6 illustrates the inner part of a cover of a substrate processing apparatus according to a second preferred embodiment of the present invention; and

FIG. 7 illustrates the flow of operations for processing a substrate.

### DESCRIPTION OF THE PREFERRED EMBODIMENTS

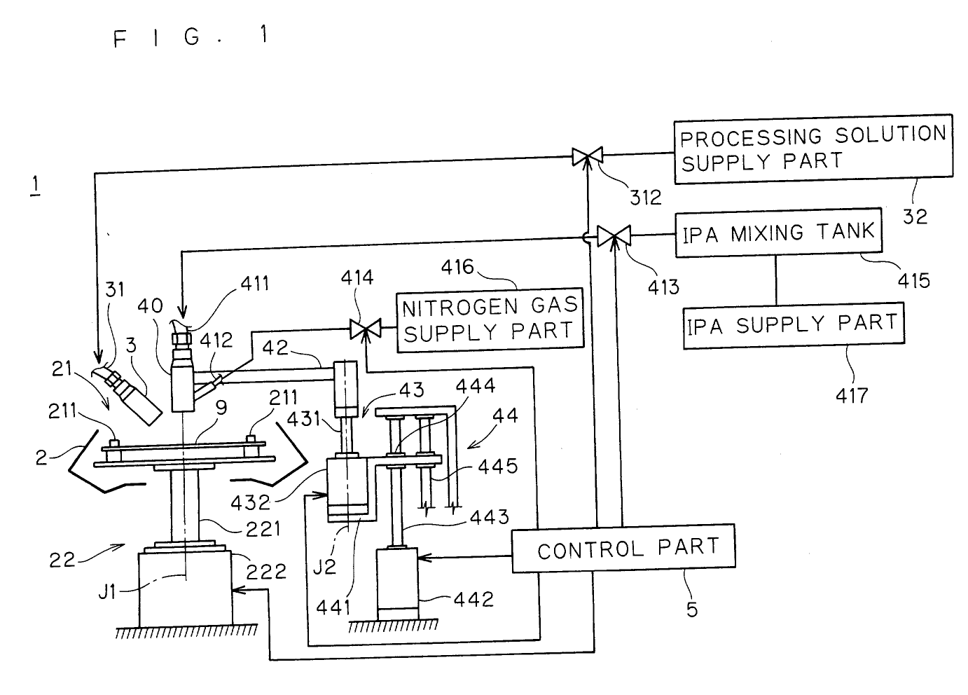

FIG. 1 schematically illustrates the structure of a substrate processing apparatus 1 according to a first preferred embodiment of the present invention. This substrate processing apparatus 1 discharges various types of processing solutions toward a substrate 9 thereby processing and cleaning the substrate 9.

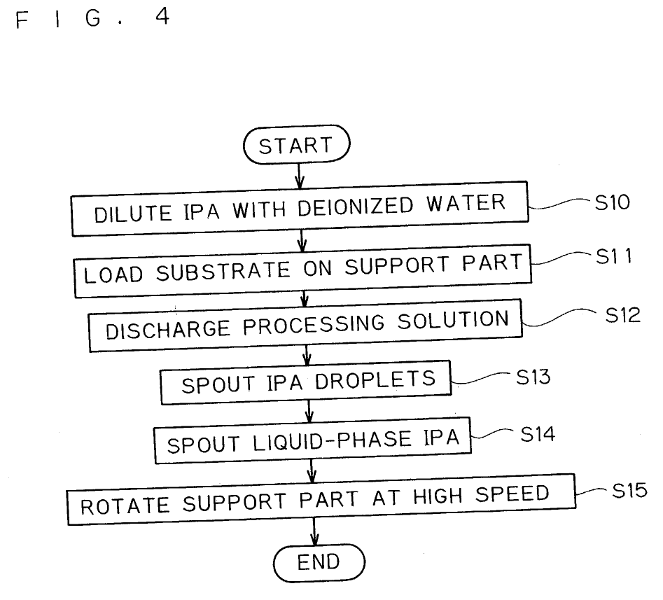

The substrate processing apparatus 1 has a cup 2 storing the processed substrate 9 and a discoidal support part 21 supporting the substrate 9 in the cup 2, while the support part 21 is connected to a lower support part drive mechanism 22. A plurality of chuck pins 211 are movably provided on the outer periphery of the support part 21, for grasping the substrate 9 on the support part 21. The support part drive mechanism 22 has a shaft 221 connected to the lower surface of the support part 21 and a motor 222 rotating the shaft 221 about a rotation axis J1. While the lateral periphery of the cup 2 is covered as described later (see FIG. 3), FIG. 1 omits illustration of such a cover 20.

A processing solution discharge nozzle 3 is provided above the support part 21 for discharging a processing solution such as an etching solution toward an objective surface (the upper major surface) of the substrate 9. The processing solution discharge nozzle 3 is connected with a processing solution supply pipe 31, which in turn is connected to a processing solution supply part 32 through a control valve 312. The processing solution discharge nozzle 3 is rendered reciprocative with respect to the objective surface of the substrate 9 by a mechanism (not shown).

An IPA spouting nozzle 40 is further provided above the support part 21 for spouting or spraying droplets of IPA toward the objective surface of the substrate 9. As shown in FIG. 1, the IPA spouting nozzle 40 is supported by an arm 42, which in turn is connected to a nozzle swinging mechanism 43. The nozzle swinging mechanism 43, having a shaft 431 rotated about a rotation axis J2 and a motor 432 connected with an end of the shaft 431, controls the motor 432 thereby swinging the IPA spouting nozzle 40 about the rotation axis J2 along the objective surface of the substrate 9.

The nozzle swinging mechanism 43 is fixed to a vertical movement stage 441 of a nozzle elevator mechanism 44, and rendered vertically movable. In the nozzle elevator mechanism 44, a nut 444 fixed to the vertical movement stage 441 is mounted on a ball screw 443, which in turn is connected with a motor 442. When the motor 442 rotates, the vertical movement stage 441 smoothly vertically moves along a guide rail 445 with the nut 444.

The IPA spouting nozzle 40 is connected with an IPA supply pipe 411 and a nitrogen gas supply pipe 412. The IPA supply pipe 411 and the nitrogen gas supply pipe 412 are connected to an IPA mixing tank 415 and a nitrogen gas supply part 416 through control valves 413 and 414 respectively. Opening/closure of the control valves 413 and 414 is so controlled as to supply IPA and nitrogen gas to the IPA spouting nozzle 40.

An IPA supply part 417 storing liquid-phase IPA is connected to the IPA mixing tank 415, for supplying the liquid-phase IPA to the IPA mixing tank 415. A deionized water supply part (not shown) is connected to the IPA mixing tank 415 for supplying deionized water to the IPA mixing tank 415, which in turn dilutes the liquid-phase IPA to prescribed concentration. Thus, diluted IPA is supplied to the IPA spouting nozzle 410. The diluted IPA is hereinafter simply referred to as “IPA”.

The substrate processing apparatus 1 further includes a control part 5, which is connected with the support part drive mechanism 22, the nozzle swinging mechanism 43, the nozzle elevator mechanism 44 and the control valves 312, 413 and 414. The control part 5 controls operations of these elements, so that the substrate processing apparatus 1 processes the substrate 9.

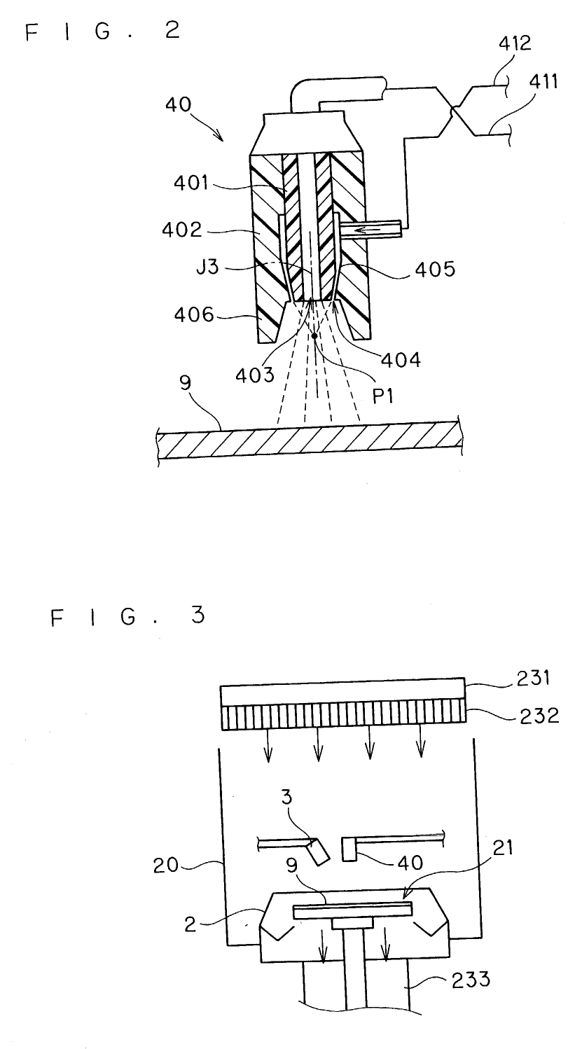

FIG. 2 is a longitudinal sectional view of the IPA spouting nozzle 40. The IPA spouting nozzle 40, connected with the IPA supply pipe 411 and the nitrogen gas supply pipe 412 as hereinabove described, mixes two types of fluids (gas and liquid) with each other thereby forming droplets. Such a nozzle is hereinafter referred to as “double-fluid nozzle”. The substrate 9 is located under the IPA spouting nozzle 40. The structure of the IPA spouting nozzle 40 and the manner of forming the droplets of IPA are now described.

The IPA spouting nozzle 40 has an inner nozzle member 401 connected with the IPA supply pipe 411 on its center, and an outer nozzle member 402 connected with the nitrogen gas supply pipe 412 is provided around the inner nozzle member 401. The inner nozzle member 401 is in the form of a cylinder having a central axis J3, and a spouting port (hereinafter referred to as “IPA spouting port”) 403 of the inner nozzle member 401 is arranged in opposition to the objective surface of the substrate 9. Thus, the IPA spouting port 403 spouts the IPA supplied from the IPA supply pipe 411 toward the objective surface of the substrate 9 along the central axis J3.

A clearance 405 is defined between the inner nozzle member 401 and the outer nozzle member 402, so that the nitrogen gas supply pipe 412 is connected to the clearance 405. The clearance 405 annularly opens around the IPA spouting port 403, to define another spouting port (hereinafter referred to as “gas spouting port”) 404 for the nitrogen gas. The diameter of the clearance 405 centering on the central axis J3 is reduced toward the gas spouting port 404, which in turn powerfully spouts the nitrogen gas supplied from the nitrogen gas supply pipe 412.

The spouted nitrogen gas is converged on a point P1 of the central axis J3 separating from the IPA spouting port 403 by a prescribed distance, and mixed with the IPA spouted from the IPA spouting port 403 on the point P1. Due to this mixing, the liquid-phase IPA forms spray of droplets (hereinafter referred to as “IPA droplets”), which in turn are directed to the substrate 9 by the nitrogen gas at a high speed.

A cylindrical projection 406 projecting toward the substrate 9 is provided around the gas spouting port 404, for preventing the IPA and the IPA droplets from outwardly spreading in a direction separating from the central axis J3.

The IPA droplets spouted toward the objective surface of the substrate 9 collide with the objective surface at a high speed, whereby particles can be physically removed from the objective surface. Also when a water-repellent or porous film is formed on the objective surface of the substrate 9, the IPA droplets can be efficiently supplied to the overall objective surface without damaging the characteristics of the film.

As hereinabove described, the IPA spouting nozzle 40, which is the so-called external mix double-fluid nozzle externally mixing the IPA and the nitrogen gas with each other for forming the IPA droplets, can readily form the IPA droplets.

The inner nozzle member 401 and the outer nozzle member 402 forming the forward end of the IPA spouting nozzle 40 are made of conductive resin utilizing PEEK (poly(etheretherketone)) resin or the like, and grounded. Thus, the IPA is inhibited from electrification upon spouting at a high speed. The IPA has a function of removing charges, thereby suppressing electrostatic damage on electronic elements or the like formed on the objective surface of the substrate 9.

Particle removal efficiency is maximized when the angle formed by the direction of spouting (the direction of the central axis J3) of the IPA spouting nozzle 40 and the objective surface of the substrate 9 is 90°, and the angle formed by the direction of spouting and the objective surface is preferably set to at least 45°. The distance between the forward end of the IPA spouting nozzle 40 and the objective surface of the substrate 9, i.e., the distance between the spouting port 403 and a droplet applying region, is preferably set to at least 5 mm and not more than 50 mm, since the removal efficiency is not damaged and the substrate processing apparatus 1 can be readily designed with this distance.

FIG. 3 shows the relation between the cover 20 (not shown in FIG. 1) and the cup 2. The cover 20, which is in the form of a (cylindrical or prismatic) tube formed around the support part 21, is mounted on the cup 2 to extend in a direction perpendicular to the objective surface of the substrate 9 supported on the support part 21. An arm inserted from a prescribed insertion opening of the cover 20 supports the processing solution discharge nozzle 3 and the IPA spouting nozzle 40.

A fan unit 231 is provided above the cover 20 for forming an air current downwardly directed toward the back surface from the objective surface of the substrate 9 in the cover 20 through an HEPA filter 232, and an exhaust port 233 provided under the support part 21 exhausts air from the cover 20. Thus, the concentration of the IPA gas is reduced around the support part 21.

The explosion limit concentration of IPA is 2.5 to 12.0 vol. %, and the volatile IPA is remarkably volatilized when simply spouted from the nozzle 40. It has been experimentally confirmed that the IPA is volatilized by 26.6% when the IPA and the nitrogen gas are simultaneously supplied to the IPA spouting nozzle 40 by 100 cc per minute and 100 L (liters) per minute respectively. It has also been confirmed that the concentration of the IPA gas is reduced to 0.78 vol. % and the concentration thereof is remarkably reduced below the explosion limit concentration when the fan unit 231 forms a downflow (supply and exhaust) of 1 m³ per minute.

The cover 20 of the substrate processing apparatus 1 is so shaped that the minimum width thereof is less than 700 mm in relation to a direction parallel to the objective surface of the substrate 9. According to “RECOMMENDED PRACTICE for Protection against Hazards arising out of Static Electricity in General Industries” p. 51, which is determined and revised on March, 1988 by “Research Institute of Industrial Safety” (Kiyose-shi, Tokyo, Japan) and is published from “Technology Institution of Industrial Safety” (Minato-ku, Tokyo, Japan), brush discharge (electrostatic discharge) from a space charge cloud is prevented when the scale of the space charge cloud is less than 700 mm in diameter or the average field of the space charge cloud is less than 1 kV/cm. In other words, a processing space in the cover 20 is reliably prevented from electrostatic discharge when the minimum width of the cover 20 is set to less than 700 mm in relation to the horizontal direction.

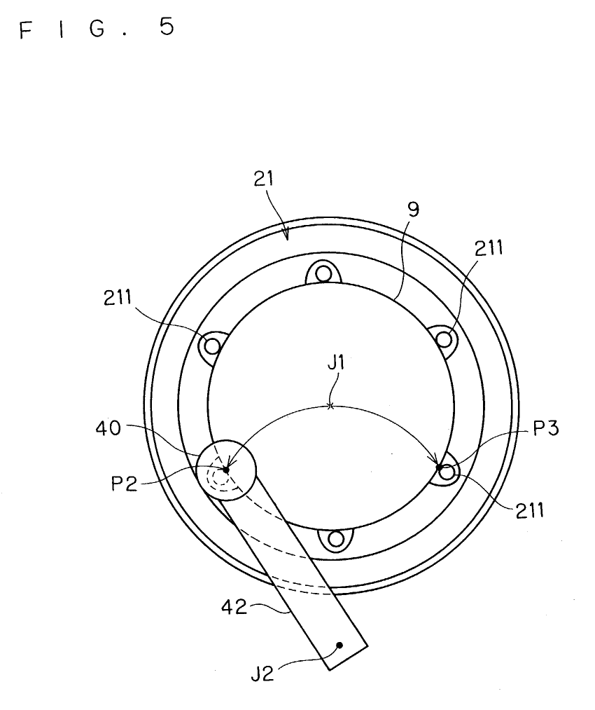

The flow of operations of the substrate processing apparatus 1 is now described. FIG. 4 illustrates the flow of the operations of the substrate processing apparatus 1 processing the substrate 9.

First, the IPA mixing tank 415 previously mixes the undiluted IPA and the deionized water with each other for forming diluted IPA (step S10), and the substrate processing apparatus 1 loads and places the processed substrate 9 on the support part 21 (step S11). At this time, the substrate processing apparatus 1 opens an outlet (not shown) provided on the cover 20 thereby introducing the substrate 9 into the cover 20. The substrate processing apparatus 1 may alternatively load the substrate 9 on the support part 21 by vertically moving the cover 20 with a separately provided elevator mechanism or the like.

Then, the control part 5 controls the control valve 312 so that the processing solution discharge nozzle 3 discharges a prescribed processing solution toward the substrate 9 (step S12), and the support part drive mechanism 22 rotates the substrate 9 thereby spreading the processing solution toward the overall objective surface for processing the substrate 9 with the processing solution.

Then, the control part 5 controls the nozzle elevator mechanism 44 for vertically moving the IPA spouting nozzle 40 until the distance between the IPA spouting nozzle 40 and the objective surface of the substrate 9 reaches a prescribed value. The control part 5 controls the control valves 413 and 414 thereby adjusting the flow rates of the IPA and the nitrogen gas, so that the IPA spouting nozzle 40 powerfully spouts the IPA droplets formed by mixing the IPA and the nitrogen gas with each other as hereinabove described toward the substrate 9 (step S13). The substrate 9 is continuously rotated with speed control in this spouting operation of the IPA droplets.

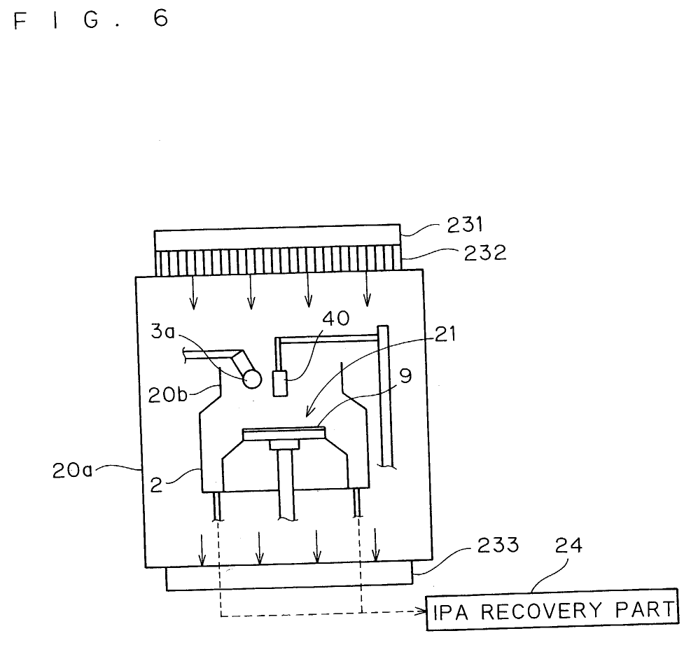

In the spouting operation of the IPA droplets, further, the nozzle swinging mechanism 43 swings the IPA spouting nozzle 40. FIG. 5 shows the operation of the nozzle swinging mechanism 43 swinging the IPA spouting nozzle 40.

As shown in FIG. 5, the nozzle swinging mechanism 43 (see FIG. 1) drives the arm 42 about the rotation axis J2 thereby swinging the IPA spouting nozzle 40 fixed to the forward end of the arm 42 on the substrate 9. At this time, the IPA spouting nozzle 40 is swung to positions P2 and P3 in FIG. 5 intersecting with the outer edge of the substrate 9 while passing through the rotation axis J1 of the substrate 9 (the support part 21). Due to such swinging of the IPA spouting nozzle 40 and rotation of the substrate 9, it follows that the IPA spouting nozzle 40 spouts the IPA droplets toward the overall objective surface of the substrate 9, for entirely cleaning the objective surface.

In order to sufficiently attain the effect of cleaning with the IPA droplets, the control part 5 controls the control valves 413 and 414 to spout the IPA droplets at a speed of at least 10 m and not more than 300 m per second (see FIG. 1). Thus, particles are effectively removed from the substrate 9 without rupturing a pattern on the substrate 9.

The substrate processing apparatus 1 uses IPA droplets of 5 to 20 μm in grain diameter obtained by setting the flow rates of the nitrogen gas and the IPA supplied to the IPA spouting nozzle 40 to 50 to 100 L per minute and 100 to 150 mL per minute respectively.

When the substrate 9 is completely cleaned with the spouted IPA droplets (the spray of IPA droplets), the control part 5 closes the control valve 414 thereby stopping supplying the nitrogen gas so that the IPA spouting nozzle 40 spouts (discharges) only the liquid-phase IPA onto the substrate 9 (step S14). Thus, the overall objective surface of the substrate 9 is filled with the liquid-phase IPA. At this time, the substrate processing apparatus 1 may stop rotating the substrate 9. Thereafter the support part drive mechanism 22 rotates the support part 21 at a high speed thereby scattering and volatilizing the IPA on the substrate 9 and drying the substrate 9 without leaving drying streaks on the objective surface thereof (step S15).

The aforementioned substrate processing apparatus 1 can efficiently clean the objective surface of the substrate 9 by spouting the IPA droplets toward the substrate 9 while inhibiting the pattern on the objective surface from rupture. Also when a water-repellent film is formed on the objective surface of the substrate 9, the IPA having smaller surface tension than water is so sufficiently supplied to the overall objective surface that particles can be removed. Further, the substrate processing apparatus 1 can readily carry out a series of steps of cleaning, rinsing and drying.

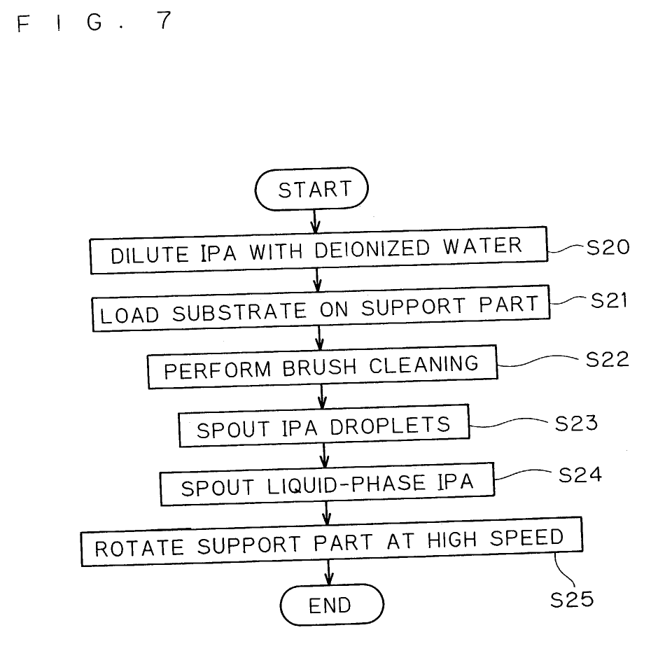

FIG. 6 illustrates the inner part of a cover 20a of a substrate processing apparatus according to a second embodiment of the present invention. The substrate processing apparatus shown in FIG. 6 is provided with a brush part 3a in place of the processing solution discharge nozzle 3 of the substrate processing apparatus 1 shown in FIG. 1. A partition member 20b is provided on an upper portion of a cup 2 arranged in the cover 20a to cover the periphery of a support part 21. The partition member 20b is substantially in the form of a cylinder centering on the support part 21, and the diameter thereof is set to less than 700 mm. Thus, electrostatic discharge is prevented in the partition member 20b. An IPA recovery part 24 is provided under the cup 2 for recovering an IPA waste liquid scattered from a substrate 9 to downwardly flow along the inner side surface of the cup 2. The IPA recovered by the IPA recovery part 24 is recycled and reused through a separately provided filter or the like.

The remaining structure of the substrate processing apparatus shown in FIG. 6 is similar to that of the substrate processing apparatus 1 shown in FIG. 1. In other words, an IPA spouting nozzle 40 is arranged in opposition to an objective surface of the substrate 9, while a fan unit 231 forms a downflow of clean air in the cover 20a through an HEPA filter 232.

FIG. 7 shows the flow of operations of the substrate processing apparatus shown in FIG. 6 processing the substrate 9. The flow of the operations shown in FIG. 7 is now described with reference to FIG. 6 (and reference numerals shown in FIG. 1).

First, the substrate processing apparatus forms diluted IPA similarly to the operation shown in FIG. 4 (step S20), and loads the substrate 9 on the support part 21 (step S21). A control part 5 rotates the support part 21, while the brush part 3a performs brush cleaning (step S22). After completion of the brush cleaning, the IPA spouting nozzle 40 spouts IPA droplets toward the substrate 9 (step S23). Thus, the objective surface of the substrate 9 is further cleaned after the brush cleaning.

When the substrate 9 is completely cleaned with the IPA droplets, the control part 5 closes a control valve 414 so that the IPA spouting nozzle 40 spouts (discharges) liquid-phase IPA toward the substrate 9 (step S24). Thereafter the substrate processing apparatus rotates the support part 21 at a high speed for scattering and volatilizing the IPA remaining on the substrate 9 and drying the substrate 9 (step S25). As hereinabove described, the substrate processing apparatus shown in FIG. 6 cleans the substrate 9 with the IPA droplets after physically cleaning the substrate 9 with the brush part 3a.

While the embodiments of the present invention have been described, the present invention is not restricted to the aforementioned embodiments but various modifications are employable.

The IPA spouting nozzle 40 may be the so-called internal mix double-fluid nozzle mixing IPA and nitrogen gas with each other in the nozzle 40 for forming IPA droplets. However, the so-called external mix double-fluid nozzle described with reference to the aforementioned first embodiment has such advantages that no particles are formed therein and no liquid unnecessarily drops from the forward end of the nozzle 40 dissimilarly to the internal mix double-fluid nozzle.

The IPA mixing tank 415 may be previously supplied with diluted IPA, or the IPA supply pipe 411 may be provided with a mixing valve for diluting IPA therein. While the IPA may not necessarily be diluted, the usage and the quantity of volatilization of the IPA can be reduced by dilution. When diluted, the content of the IPA is preferably set to at least 10% for maintaining an antistatic effect of the IPA. The IPA concentration may not be strictly uniform.

The gas supplied to the IPA spouting nozzle 40 is not restricted to the nitrogen gas but another inert gas may alternatively be employed. The substrate processing apparatus may be provided with a plurality of support parts 21 for processing a plurality of substrates in parallel with each other.

The cover 20 may alternatively have another shape so far as the same is tubular. The partition member 20b, preferably cylindrical in correspondence to the opening of the cup 2, may alternatively have another tubular shape. The cover 20 and the partition member 20b are not strictly distinguished from each other but the partition member 20b shown in FIG. 6 may play the role of an inner cover arranged in the cover 20a. Further, the cover 20 and the partition member 20b may be separated from the cup 2. The object of preventing electrostatic discharge can be attained when the cover 20 and the partition member 20b are substantially tubular and receive no sphere of 700 mm in diameter therein (a space having the objective surface of the substrate 9 as a bottom surface).

In the substrate processing apparatus shown in FIG. 6, the cover 20a may be provided therein with a nozzle swinging mechanism 43 (not shown) or a nozzle elevator mechanism 44 (not shown).

The substrate processing apparatus 1 may be provided with both of the processing solution discharge nozzle 3 and the brush part 3a, or only the IPA spouting nozzle 40. Further, the substrate processing apparatus may alternatively perform other physical cleaning as cleaning other than the brush cleaning. The processing and the cleaning of the substrate 9 by the substrate processing apparatus 1 are not restricted to the processing and the cleaning of the upper surface of the substrate 9, but may alternatively be performed on the lower surface.

At the step S14 or S24, the liquid-phase IPA may alternatively be discharged toward the substrate 9 from a separately provided nozzle. Further, the step S14 or S24 may be omitted for drying the substrate 9 with the IPA adhering thereto when spouting the IPA droplets.

While the invention has been shown and described in detail, the foregoing description is in all aspects illustrative and not restrictive. It is therefore understood that numerous modifications and variations can be devised without departing from the scope of the invention.

What is claimed is:

1. A substrate processing apparatus comprising:
a support part supporting a substrate; and
a nozzle part spouting IPA droplets toward an objective surface of said substrate supported by said support part.

2. The substrate processing apparatus according to claim 1, wherein said nozzle part mixes liquid-phase IPA with inert gas thereby forming said IPA droplets.

3. The substrate processing apparatus according to claim 2, further comprising a swinging mechanism swinging said nozzle part along said objective surface of said substrate.

4. The substrate processing apparatus according to claim 3, further comprising:
an IPA supply part storing said liquid-phase IPA, and
a mixing part diluting said liquid-phase IPA received from said IPA supply part with deionized water.

5. The substrate processing apparatus according to claim 4, wherein a distance between the forward end of said nozzle part and said objective surface of said substrate is set to at least 5 mm and not more than 50 mm.

6. The substrate processing apparatus according to claim 5, wherein an angle formed by a spouting direction of said IPA droplets from said nozzle part and said objective surface of said substrate is at least 45°.

7. The substrate processing apparatus according to claim 6, wherein a speed of said IPA droplets spouted from said nozzle part is at least 10 m and not more than 300 m per second.

8. The substrate processing apparatus according to claim 7, wherein said nozzle part has a forward end made of conductive resin.

9. The substrate processing apparatus according to claim 8, wherein said nozzle part comprising:
an IPA spouting port spouting said liquid-phase IPA toward a prescribed mixing position, and
a gas spouting port spouting said inert gas toward said mixing position, and
said liquid IPA and said inert gas are spouted to be immediately mixed with each other at said mixing position.

10. The substrate processing apparatus according to claim 9, further comprising:
a substantially cylindrical partition member covering a periphery of said support part, wherein
a diameter of said partition member is less than 700 mm.

11. The substrate processing apparatus according to claim 9, further comprising:
a tubular cover, provided therein with said support part and said nozzle part, extending in a direction perpendicular to said objective surface of said substrate, wherein
a minimum width of said cover is less than 700 mm in a direction parallel to said objective surface of said substrate.

12. The substrate processing apparatus according to claim 11, further comprising:
an air current formation part forming an air current directed toward a back surface of said substrate from said objective surface around said support part.

13. The substrate processing apparatus according to claim 12, further comprising:
a discharge part discharging a processing solution toward said substrate.

14. A substrate cleaning method, comprising:
a supporting step of supporting a substrate on a prescribed position; and
a cleaning step of spouting IPA droplets toward an objective surface of said substrate to thereby clean said objective surface of said substrate.

15. The substrate cleaning method according to claim 14, further comprising:
a processing solution supplying step of supplying a prescribed processing solution toward said substrate in advance of said cleaning step.

16. The substrate cleaning method according to claim 15, further comprising:
another cleaning step of physically cleaning said substrate in advance of said cleaning step.

17. The substrate cleaning method according to claim 16, further comprising:
a drying step of removing IPA adhering to said substrate to thereby dry said objective surface of said substrate after said cleaning step.

18. The substrate cleaning method according to claim 17, further comprising:
an additional IPA supplying step of separately supplying additional IPA toward said substrate between said cleaning step and said drying step.

19. The substrate cleaning method according to claim 18, further comprising:
a dilution step of diluting IPA liquid with deionized water to thereby obtain said liquid-phase IPA to be spouted in said cleaning step.
